(19) United States
(12) Patent Application Publication
(10) Pub. No.: US 2026/0039140 A1
(43) Pub. Date: Feb. 5, 2026

(54) Power Supply Unit Management in Network Devices

(71) Applicant: Cisco Technology, Inc., San Jose, CA (US)

(72) Inventors: RIver Lin, San Jose, CA (US); Ruqi Li, San Jose, CA (US); John W. Beecroft, San Jose, CA (US); Joel Richard Goergen, Soulsbyville, CA (US); Beth Kochuparambil, Morgan Hill, CA (US); Shobhana R. Punjabi, San Jose, CA (US); Kami Hurst, San Jose, CA (US); Phen Lumod, San Jose, CA (US); Alpesh U. Bhobe, San Jose, CA (US)

(21) Appl. No.: 18/793,708

(22) Filed: Aug. 2, 2024

(51) Int. Cl. H02J 9/00; G06F 1/28; H02J 9/06

(52) U.S. Cl. CPC H02J 9/005; G06F 1/28; H02J 9/061

(57) ABSTRACT

Devices, systems, methods, and processes for operating a plurality of power supplies of a network device using cold redundancy are described herein. Traditionally, redundant power supplies are operated in parallel with primary power supplies, thus making power supply system less efficient. To address these issues, an analog architecture is provided for implementing cold redundancy in a network device. Each power supply includes two pins: one for designating the power supply as primary or secondary, and the other pin for configuring an activity state of the power supply. The activity state can be an active state or a sleep state. The secondary power supplies are further ranked in an order of priority using different voltage levels for assignment. In response to surge in load demand, activity states of one or more secondary power supplies are changed to the active state without requiring a signal from a centralized control software.

The present disclosure relates to network devices. More particularly, the present disclosure relates to managing primary and secondary power supplies of the network devices.

### BACKGROUND

Networking equipment (for example, router, switches, hubs, servers, firewalls, etc.) typically require reliable and uninterrupted power supply for their operation. To address potential power issues such as voltage fluctuations and power instability, network device architectures are often provided with redundant power supplies. Such redundancy may ensure continuous service and minimized downtime due to power-related problems.

Various examples of redundant power supply configurations include an N+1 configuration, an N+N configuration, or an N+M configuration. In the N+1 configuration, there are ‘N’ primary power supplies and one redundant power supply to take over if any primary supply fails. In the N+N configuration, there are ‘N’ primary power supplies and an equal number of redundant power supplies. In the N+M configuration, there are ‘N’ primary power supplies and ‘M’ redundant power supplies, where M can be any number needed to meet specific reliability requirements.

Typically, in a hot redundancy setup, redundant power supplies operate in parallel with the primary power supplies. Since load is shared among the primary and redundant power supplies, keeping all power supplies active simultaneously can result in inefficient operation. For example, each power supply, whether primary or redundant, may end up operating below its optimal efficiency range. As a result, the overall energy efficiency of the system may decrease, leading to wasted energy and decreased overall system performance.

### SUMMARY OF THE DISCLOSURE

Systems and methods for managing primary and secondary power supplies in network devices in accordance with embodiments of the disclosure are described herein. In some embodiments, a power supply system includes a system board, two or more power supplies electrically coupled to the system board, wherein each of the two or more power supplies is configured with a first pin and a second pin, the first pin is utilized by each of the two or more power supplies to determine an assignment, and the second pin is utilized by each of the two or more power supplies to determine an activity state.

In some embodiments, the assignment is configured to indicate that one of the two or more power supplies is a primary power supply.

In some embodiments, the assignment is configured to indicate that remaining power supplies of the two or more power supplies is a secondary power supply.

In some embodiments, each of the secondary power supplies are ranked within an order of priority.

In some embodiments, the ranks include at least a first secondary, a second secondary, and a third secondary.

In some embodiments, the activity state includes an active state.

In some embodiments, the activity state includes a sleep state.

In some embodiments, the primary power supply is configured with an active state.

In some embodiments, the second pin is configured to be associated with a voltage level that is present at the second pin and is readable by the power supply.

In some embodiments, the activity state is changed in response to a change in the voltage level present at the second pin.

In some embodiments, each of the two or more power supplies is configured to change corresponding activity state in response to both a current assignment and the voltage level at the second pin.

In some embodiments, the change in activity state is based on a predetermined operational configuration.

In some embodiments, the predetermined operational configuration is setup through one or more logic circuits.

In some embodiments, the change in activity state occurs in less than 100 milliseconds.

In some embodiments, the change in activity state occurs without a signal from a centralized control software.

In some embodiments, a power supply includes at least one logic circuit, a first configuration pin configured to determine an assignment, and a second configuration pin associated with a voltage level that is utilized by the at least one logic circuit to determine an activity state of the power supply.

In some embodiments, the assignment is configured to indicate that the power supply is either a primary power supply or a secondary power supply.

In some embodiments, activity state is either an active state or a sleep state.

In some embodiments, the voltage level is checked in a periodic interval.

In some embodiments, a method of managing power supplies includes determining an assignment among a plurality of power supplies coupled to a system board wherein the assignment is determined by a voltage applied to a first configuration pin on each of the plurality of power supplies, selecting an activity state for each of the plurality of power supplies based on the determined assignments, providing a voltage to a second configuration pin disposed on each of the plurality of power supplies, and changing the activity state of at least one of the plurality of power supplies based on the provided voltage to the second configuration pin.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram of a network device including multiple power supplies in accordance with various embodiments of the disclosure;

FIG. 2 is a conceptual illustration of an efficiency curve of a PSU in a network device in accordance with various embodiments of the disclosure;

FIG. 3 is a conceptual illustration of a PSU utilized in a network device with cold redundancy setup in accordance with various embodiments of the disclosure;

FIG. 4 is a conceptual diagram of a power supply system for a network device in accordance with various embodiments of the disclosure;

FIG. 5 is a graphical illustration depicting voltage levels mapped to different assignments in accordance with various embodiments of the disclosure;

FIG. 6 is a graphical illustration depicting a change in activity state of PSUs in accordance with various embodiments of the disclosure;

FIG. 7 is a flowchart showing a process of operating a power supply unit (PSU) with two analog pins in accordance with various embodiments of the disclosure;

FIG. 8 is a flowchart showing a process for operating a primary PSU in a cold redundancy set up in accordance with various embodiments of the disclosure; and

FIG. 9 is a flowchart showing a process for a power supply system with two or more PSUs and a system board in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide an analog architecture for operating a plurality of power supplies of a network device in a cold redundancy setup. Network devices (for example, routers, servers, switches, hubs, firewalls, or the like) often include power supply units (interchangeably referred to as “power supplies” or “PSUs”) that provide power to internal components of the network devices. For example, the PSUs can provide power to processors, memory, networking interfaces, and other electronic components of a network device. Generally, networking equipment require reliable and uninterrupted power supply for their operation. To address potential power issues, network device architectures are often provided with redundant PSUs. Examples of redundant power supply configurations include an N+1 configuration, an N+N configuration, or an N+M configuration. In the N+1 configuration, there are ‘N’ primary PSUs and one redundant PSU to take over if any primary PSU fails. In the N+N configuration, there are ‘N’ primary PSUs and an equal number of redundant PSUs. In the N+M configuration, there are ‘N’ primary PSUs and ‘M’ redundant PSUs.

Typically, in a hot redundancy setup, the redundant PSUs operate in parallel with the primary PSU. In other words, in the hot redundancy setup, both the primary and redundant PSUs are kept active simultaneously. Thus, if any primary PSU fails, the redundant PSU takes over and supplies power to the load seamlessly, for example, with no interruption. Since the load is shared among active PSUs, keeping the primary and redundant PSUs active simultaneously can result in inefficient operation, and each PSU may end up operating below its optimal efficiency range, Thus, leading to wasted energy and decreased overall system performance.

A solution to mitigate the shortcomings of the hot redundancy setup is to operate the PSUs in a cold redundancy setup instead. In the cold redundancy setup, the redundant PSUs operate in a standby state (e.g., a sleep state or a low power state) while the primary PSUs operate in the active state. In a conventional cold redundancy setup, a central system software determines which PSU will operate as the primary PSU and which will serve as the redundant backup. Such central system software can be prone to glitches or bugs, resulting in decision-making latency, frequent maintenance requirements, compatibility issues with both hardware and software. Moreover, the central system software may determine the primary and backup assignments based on historical power usage data of the PSUs, overlooking phase balancing considerations required for even load distribution across the PSUs. This oversight can result in inefficient performance. In view of the issues discussed herein, the present disclosure describes an analog architecture to operate a plurality of PSUs of a network device in a cold redundancy setup. The analog architecture may result in faster system response while improving efficiency of the cold redundancy setup.

In many embodiments, a network device (for example, routers, switches, hubs, servers, or the like) may be equipped with a plurality of PSUs connected to a system board. The analog architecture, as described in the present disclosure, may implement flexible assignment to determine which PSUs will operate as primary PSUs and which will serve as secondary PSUs, thus optimizing efficiency and load balancing. As per the analog architecture, each PSU may be provided with at least two additional pins, for example, an assignment pin (hereinafter, referred to as PIN1) and an activity state pin (hereinafter, referred to as PIN2), which serve as a connection interface to the system board.

In further embodiments, the system board may include a PSU controller configured to determine an assignment (for example, primary or secondary) and an activity state (e.g., a sleep state or an active state) for each PSU and may utilize the respective pins (e.g., PIN1 and PIN2) of each PSU to convey the assignment and the activity state. In a variety of embodiments, PIN1 may be utilized for assigning whether a PSU is to operate as a primary PSU or a secondary PSU and PIN2 may be utilized to assign an activity state (e.g., the active state or the sleep state) to each PSU. For example, the PSU controller may provide a voltage level at PIN1 of each of the plurality of PSUs to convey the corresponding assignment. Further, the PSU controller may provide a voltage level at PIN2 of each of the plurality of PSUs to convey a corresponding initial activity state. In numerous embodiments, a voltage level utilized to convey the primary assignment may be different from a voltage level utilized to convey the secondary assignment. Likewise, a voltage level utilized to convey the active state may be different from a voltage level utilized to convey the sleep state. In a number of embodiments, the primary PSU may be configured with the active state and the secondary PSUs may initially be configured with the sleep state.

In additional embodiments, the PSU controller may rank the plurality of PSUs in an order of priority. In more embodiments, the PSU controller can rank the PSUs based on predetermined operational configurations. In still further embodiments, the predetermined operational configurations may refer to an efficiency curve, a power factor, a quality of service, or other such parameters corresponding to a PSU. Based on the ranking, the PSU controller may assign at least the highest ranked PSU as the primary PSU. Further, the PSU controller can assign the remaining PSUs as secondary PSUs. In yet more embodiments, the PSU controller can further rank the secondary PSUs as a first secondary, a second secondary, a third secondary, and so on. In still yet more embodiments, the PSU controller may rank the secondary PSUs based on their respective location within the network device. For example, a secondary PSU located at a further distance from the load can be ranked lower in the order of priority than another secondary PSU located at a closer distance from the load. Thus, the secondary PSU located at the further distance can be ranked as the second secondary as compared to the nearby secondary PSU that is ranked as the first secondary. In still more embodiments, the PSU controller may store the ranking of the PSUs. In several embodiments, different secondary priorities may be indicated by providing different voltage levels at PIN1 of the secondary PSUs.

In numerous additional embodiments, the PSU controller may also store various voltage levels utilized for the assignment of the plurality of PSUs and activation threshold voltage levels corresponding to different assignments. For example, the PSU controller may store a mapping associating different voltage levels to different assignments and a list of activation thresholds corresponding to the different assignments.

In a number of embodiments, a primary PSU may be configured to change the activity state of any of the secondary PSUs based on a load requirement. For example, if load demand increases beyond a capacity of the primary PSU operating in the active state, the primary PSU may change a voltage level at its PIN2. Change in the voltage level at the PIN2 of the primary PSU may also be reflected at the PIN2 of each of the secondary PSUs. For example, PIN2 of all PSUs can be connected or the PSU controller may cause the voltage level change at the PIN2 of each of the secondary PSUs in response to the change at the voltage level of the primary PSU. Based on the change in the voltage level at the PIN2 of each of the secondary PSUs, at least one of the secondary PSUs whose activation threshold matches the new voltage level at the PIN2 may change the activity state from the sleep state to the active state. In more examples, where the primary PSU fails, the PSU controller may change a voltage level at PIN1 of at least one secondary PSU to change the assignment from secondary to primary and may further change a voltage level at PIN2 to change the activity state from the sleep state to the active state. In many further embodiments, the change in the activity state can occur in less than 100 milliseconds. Further, the change in the activity state can occur without a signal from a centralized control software of the network device.

In a number of embodiments, each PSU may include a logic circuit coupled to PIN1 and PIN2. The logic circuit may read voltage levels provided at PIN1 and PIN2 and may accordingly determine the assignment (e.g., primary or secondary) and the activity state (e.g., the sleep state or the active state) for the PSU. In many additional embodiments, the logic circuit may check the voltage levels of PIN1 and PIN2 in periodic intervals, for example, after every 5 seconds, 10 seconds, or the like. In still yet further embodiments, the logic circuit may be configured to store a voltage to assignment mapping that can be utilized to interpret the voltage level read at PIN1. Likewise, the logic circuit may further store a predetermined operational configuration, for example, an activation threshold value, that can be utilized to interpret the voltage level read at PIN2. For example, if the voltage level at PIN2 is below the activation threshold value, the logic circuit may operate the PSU in the active state and if the voltage level at PIN2 exceeds the activation threshold value, the logic circuit may change the activity state from the sleep state to the active state. In several more embodiments, PIN2 of all PSUs may be interconnected, thus, the primary PSU can control a voltage level output at its PIN2 to change the activity state of one or more secondary PSUs, when required.

In several more embodiments, the two pins, PIN1 and PIN2, in each PSU may operate as bidirectional communication pins, allowing the PSU to provide output voltages and read voltage levels provided by the PSU controller. Through these bidirectional PINs, the PSUs can communicate their respective output voltage levels to other PSUs.

In still more embodiments, the network device may include an Application-Specific Integrated Circuit (ASIC) that can be used for monitoring, power management, and control of the PSUs. ASIC is a type of integrated circuit (IC) that is designed for a specific application or purpose. The ASIC may monitor the health and status of each PSU and may control the power-up sequence for the PSUs. The ASIC can, therefore, control the order of priority of the PSUs. In still further embodiments, the analog mechanism described in the present disclosure does not require centralized software.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

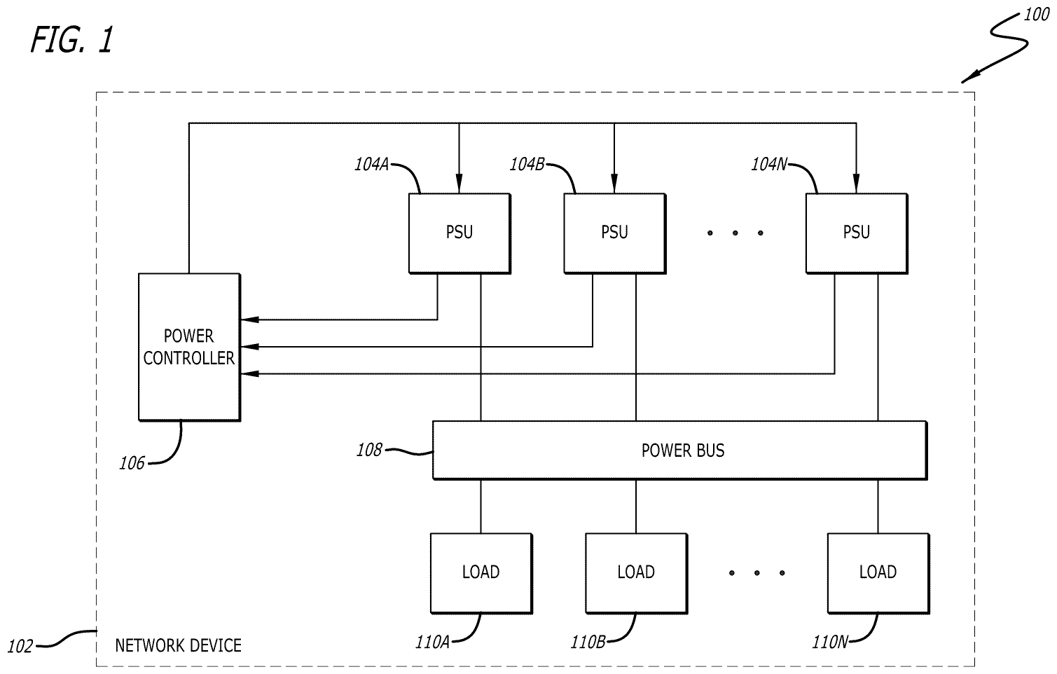

Referring to FIG. 1, a conceptual diagram 100 of a network device including multiple power supplies in accordance with various embodiments of the disclosure is shown. In many embodiments, the conceptual diagram 100 illustrates a network device 102 having a plurality of power supply units (PSUs), for example, PSUs 104A, 104B, . . . , 104N. The network device 102 may refer to any networking equipment such as a router, a switch, an access point, a server, a firewall, or the like. In a variety of embodiments, at least one of the PSUs 104A-104N may be a primary PSU, and remaining PSUs can serve as secondary PSUs to provide redundancy if the primary PSU fails or is overloaded. The PSUs 104A-104N may be configured to supply power to various internal components of the network device 102, such as central processor, memory, network interface cards, cooling systems, Light Emitting Diode (LED) indicators, display panels, control and monitoring circuits, peripherals, or the like. All such internal components of the network device 102 drawing power from the PSUs 104A-104N may be referred to as load (depicted by loads 110A, 110B, . . . , 110N in the conceptual diagram 100).

In more embodiments, each of the PSUs 104A-104N may be connected to a power controller 106. The power controller 106 may be responsible for monitoring and controlling the PSUs 104A-104N. More specifically, the power controller 106 may provide load balancing among multiple PSUs 104A-104N based on load demand and/or dynamically adjusting the load distribution in real-time based on changing power demands of the loads 110A-110N. The power controller 106 may also provide redundancy management by monitoring the status of each PSU 104A-104N and can switch the load to at least one of the secondary PSUs if the primary PSU fails. The power controller 106 may also provide continuous monitoring of voltage, current, temperature, charge level, or other parameters of each PSU 104A-104N, thereby providing real-time data for system management. In still further embodiments, the power controller 106 may be an ASIC (Application-Specific Integrated Circuit) that can be specifically customized to provide optimized solutions for power management.

In still additional embodiments, each of the PSUs 104A-104N may be connected to a power bus 108. The power bus 108 may provide a centralized point for distributing power from the PSUs 104A-104N to multiple devices, internal components, or circuits within the network device 102. The power bus 108 may reduce the complexity of wiring by consolidating power lines into a single bus, thereby making the design and maintenance of power distribution system more organized.

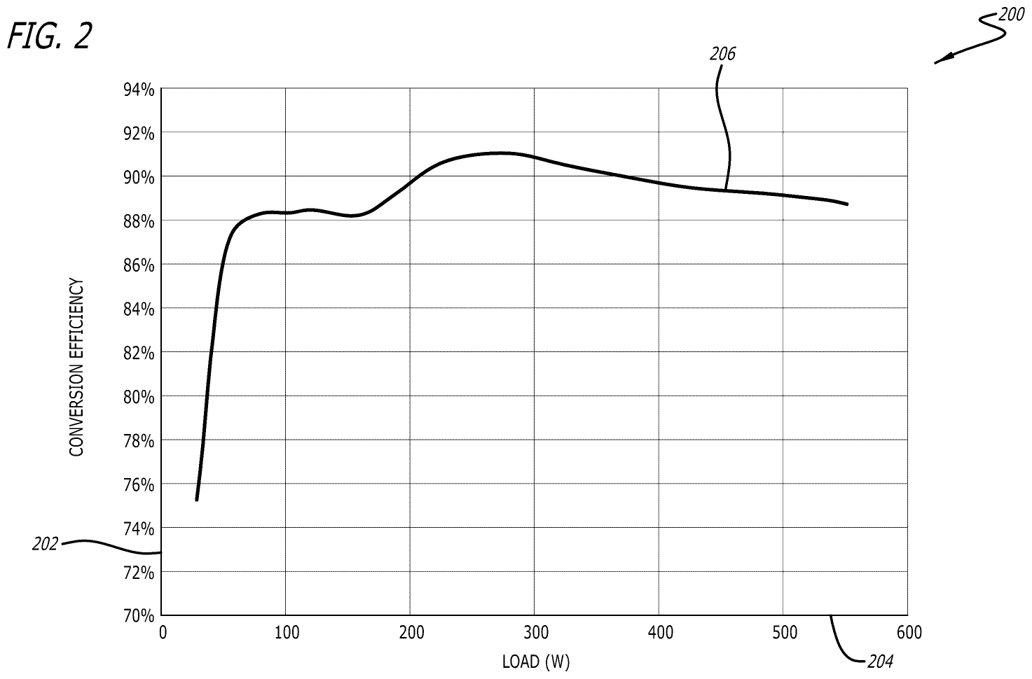

Although a specific embodiment for a network device including multiple power supplies suitable for carrying out the various steps, processes, methods, and operations described herein is discussed with respect to FIG. 1, any of a variety of systems and/or processes may be utilized in accordance with embodiments of the disclosure. In yet more embodiments, the power controller 106 may be a digital controller. The power controller 106 may utilize analog feedback signals, such as voltage or current feedback, from the PSUs 104A-104N for power management. The power controller 106 may then monitor and control various parameters of the PSUs104A-104N using sensors and ADCs (Analog-to-Digital Converters). The elements depicted in FIG. 1 may also be interchangeable with other elements of FIGS. 2-9 as required to realize a particularly desired embodiment.

Referring to FIG. 2, a conceptual illustration 200 of an efficiency curve of a PSU in a network device in accordance with various embodiments of the disclosure is shown. Efficiency of a PSU may be defined by a ratio of total output power to total input power, expressed in percentage. PSU efficiency may thus represent the amount of power delivered to the internal components of the network device divided by the electrical power drawn from mains supply socket.

In many embodiments, the conceptual illustration 200 presents a graph with PSU load plotted along the X-axis 204 and PSU efficiency plotted along the Y-axis 202. Additionally, the graph illustrates an efficiency curve 206 plotted for a PSU. As shown in FIG. 2, the PSU may run at the highest efficiency at around 50% load. More specifically, the PSU may reach peak efficiency value at around 50-60% load. The efficiency value may be around 90%. For example, as depicted in the FIG. 2, the efficiency level is maximum ˜90-95% at 50% load value, for example, at load of 250-270 W. However, as the load value increases, the efficiency value may tend to decrease. More specifically, efficiency may decrease as the load approaches 100%. For example, at 100% load, the efficiency might drop to 88%. Thus, implying that if the load value increases for a PSU, the PSU may start operating in less-than-optimal efficiency range. Thus, it may become more advantageous to run two PSUs that can share the load and operate at peak efficiencies, leading to higher overall operating efficiency.

Although a specific embodiment depicting an efficiency curve of a PSU in a network device suitable for carrying out the various steps, processes, methods, and operations described herein is discussed with respect to FIG. 2, any of a variety of systems and/or processes may be utilized in accordance with embodiments of the disclosure. In a variety of embodiments, the PSU efficiency curve may be used to determine energy consumption of a PSU at various load levels. For example, when a PSU is operating at 80% efficiency for a given load, it may indicate that 20% of the power is being dissipated as heat. The energy consumption information may be required for energy budgeting and minimizing operational costs, especially in large data centers. The elements depicted in FIG. 2 may also be interchangeable with other elements of FIGS. 1 and 3-9 as required to realize a particularly desired embodiment.

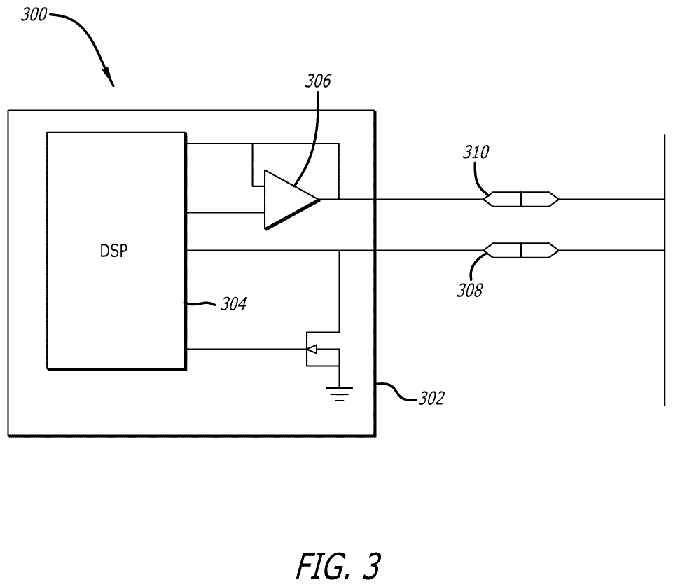

Referring to FIG. 3, a conceptual illustration 300 of a PSU utilized in a network device with cold redundancy setup in accordance with various embodiments of the disclosure is shown. The embodiments depicted in FIG. 3 may show a PSU 302 that is a part of a power supply system of a network device, for example, a router, switch, a server, a hub, a network node, or the like. In many embodiments, the PSU 302 may be configured to supply power to various internal components (e.g., processors, memory, control circuits, peripheral devices, etc.) of the network device and various external devices connected to the network device via Power Over Ethernet (POE) cables. In a number of embodiments, the PSU 302 may include a digital signal processor (DSP) 304, a comparator 306, and at least two pins, for example, a first configuration pin 308 and a second configuration pin 310.

In a variety of embodiments, the first configuration pin 308 and the second configuration pin 310 can be utilized to control the operation of the PSU 302. In more embodiments, the first configuration pin 308 may be configured to determine an assignment of the PSU 302. The assignment can indicate whether the PSU 302 is designated as a primary PSU or a secondary PSU. For example, the first configuration pin 308 may receive a voltage level of 3V if the assignment indicates a primary PSU. However, if the assignment indicates a secondary PSU, the first configuration pin 308 may receive a voltage level different than 3V. In numerous embodiments, if the PSU 302 is designated as a secondary PSU, the assignment can further indicate an order of priority (for example, first secondary, second secondary, third secondary, and so on) in which the PSU 302 is ranked. For example, a voltage level of 2.48V at the first configuration pin 308 may indicate the assignment of a first secondary PSU. Likewise, a voltage level of 1.98V at the first configuration pin 308 may indicate the assignment of a second secondary PSU. Similarly, different voltage levels can be used to indicate different assignments.

In additional embodiments, the second configuration pin 310 may be configured to indicate an activity state for the PSU 302. The activity state can be a sleep state or an active state. The second configuration pin 310 may be associated with a voltage level which indicates the activity state of the PSU 302. In further embodiments, the sleep state may refer to a low-power state in which the PSU 302 may maintain minimal functionality while reducing energy consumption. The sleep state can also be referred to as a standby or power-saving state. While operating in the sleep state, the PSU 302 may not power any load and may only allow its critical components (e.g., such as local memory, the DSP 304, real-time clock, etc.) to be powered just enough to enable quick reactivation upon change of state indication at the second configuration pin 310. In many further embodiments, the active state may refer to a state in which the PSU 302 is fully operational, for example, delivering the necessary power to connected components (e.g., load). During the active state, the PSU 302 may convert an AC power received from a power source into appropriate DC voltages required by the connected load.

In still more embodiments, the DSP 304 (e.g., a logic circuit) may be coupled to the first configuration pin 308. The DSP 304 may read a voltage level present at the first configuration pin 310 and may determine the assignment of the PSU 302. In still further embodiments, the DSP 304 may be configured to store a mapping associating different voltage levels to different assignments. For example, in the mapping, ‘3V’ may be associated with the primary PSU assignment and ‘2.48V’ may be associated with the secondary PSU assignment. Thus, based on a voltage level present at the first configuration pin 308, the DSP 304 may interpret the assignment determined for the PSU 302.

In still additional embodiments, the DSP 304 may be further coupled to the second configuration pin 310 via the comparator 306 and may read a voltage level present at the second configuration pin 310. The DSP 304 may further store a list of activation thresholds corresponding to different assignments. For example, the list of activation thresholds may indicate that a first voltage level≤3V at the second configuration pin 310 of a primary PSU may indicate that the primary PSU is in active state. Likewise, a second voltage level≤2.3V at the second configuration pin 310 of a first secondary PSU may indicate that the first secondary PSU is in the active state. Further, a third voltage level between ≤1.6V at the second configuration pin 310 of a second secondary PSU may indicate that the second secondary PSU is in the active state, and so on. Although the comparator 306 may be configured to read and compare the voltage level present at the second configuration pin with the activation thresholds, various circuits can substitute for a comparator depending on the application and requirements. One such alternative is the operational amplifier (op-amp) configured as a voltage follower with a high gain, which can perform similar comparison tasks by amplifying the difference between two input voltages. For digital signal processing, a microcontroller with built-in analog-to-digital converters (ADCs) can be programmed to compare input signals and execute conditional logic, thus replacing a traditional comparator. Another substitute is a differential amplifier circuit, which amplifies the difference between two input signals and can be used in precision applications where a comparator's speed and simplicity are less critical. For specific applications like zero-crossing detection or signal threshold monitoring, a microcontroller with integrated comparators can provide a more compact and programmable solution. Additionally, logic gates configured to mimic comparator behavior can serve as an alternative in digital circuits, though this approach might be more complex.

In still additional embodiments, the DSP 304 may be configured to determine whether the assignment indicated at the first configuration pin 308 corresponds to a primary PSU or a secondary PSU. In a scenario where the DSP 304 determines that the assignment indicated at the first configuration pin 308 corresponds to the primary PSU, the DSP 304 may be configured to control an output voltage at the second configuration pin 310. The second configuration pin 310 may be further connected to second configuration pins of other PSUs in the network device. Thus, by controlling the output voltage at the second configuration pin 310 of the PSU 302 designated as the primary PSU, the DSP 304 may control the activity state of other secondary PSUs in the network device. In an example scenario, the DSP 304 may monitor a current load demand satisfied by the PSU 302 (e.g., the primary PSU). If the current load demand is less than or equal to a peak efficiency load threshold of the PSU 302 (e.g., the primary PSU), the DSP 304 may output a voltage level at the second configuration pin 310 such that all other secondary PSUs remain in the sleep state. For example, the DSP 304 may output a voltage level ≥3V at the second configuration pin 310. If the current load demand is greater than the peak efficiency load threshold of the PSU 302 (e.g., the primary PSU), the DSP 304 may output a voltage level at the second configuration pin 310 such that at least one secondary PSU changes its activity state to the active state.

However, in a scenario where the DSP 304 determines that the assignment indicated at the first configuration pin 308 corresponds to the secondary PSU, the DSP 304 may be configured to read a voltage level present at the second configuration pin 310. If the voltage level present at the second configuration pin 310 is greater than an activation threshold setup for the current assignment of the PSU 302, the DSP 304 may operate the PSU in the sleep state. However, if the voltage level present at the second configuration pin 310 is less than or equal to the activation threshold setup for the current assignment of the PSU 302, the DSP 304 may change the activity state of the PSU 302 to the active state.

In many additional embodiments, the first configuration pin 308 and the second configuration pin 310 can be bidirectional communication pins utilized to read analog voltage levels or output continuous voltage levels.

Although a specific embodiment for a PSU utilized in a network device with cold redundancy setup suitable for carrying out the various steps, processes, methods, and operations described herein is discussed with respect to FIG. 3, any of a variety of systems and/or processes may be utilized in accordance with embodiments of the disclosure. In several more embodiments, the PSU 302 may include a single configuration pin (for example, 308) that may be configured to receive the assignment signal and the activity state signal at separate time intervals. More specifically, the single configuration pin may be configured to read the assignment signal at time instance ‘T1’ and the activity state signal at time instance ‘T2’. In numerous embodiments, the time instance ‘T1’ and ‘T2’ may indicate periodic time intervals. In a similar manner, a concept of frequency division multiplexing may be utilized to provide the assignment signal and the activity state signal on the single configuration pin. The elements depicted in FIG. 3 may also be interchangeable with other elements of FIGS. 1-2 and 4-9 as required to realize a particularly desired embodiment.

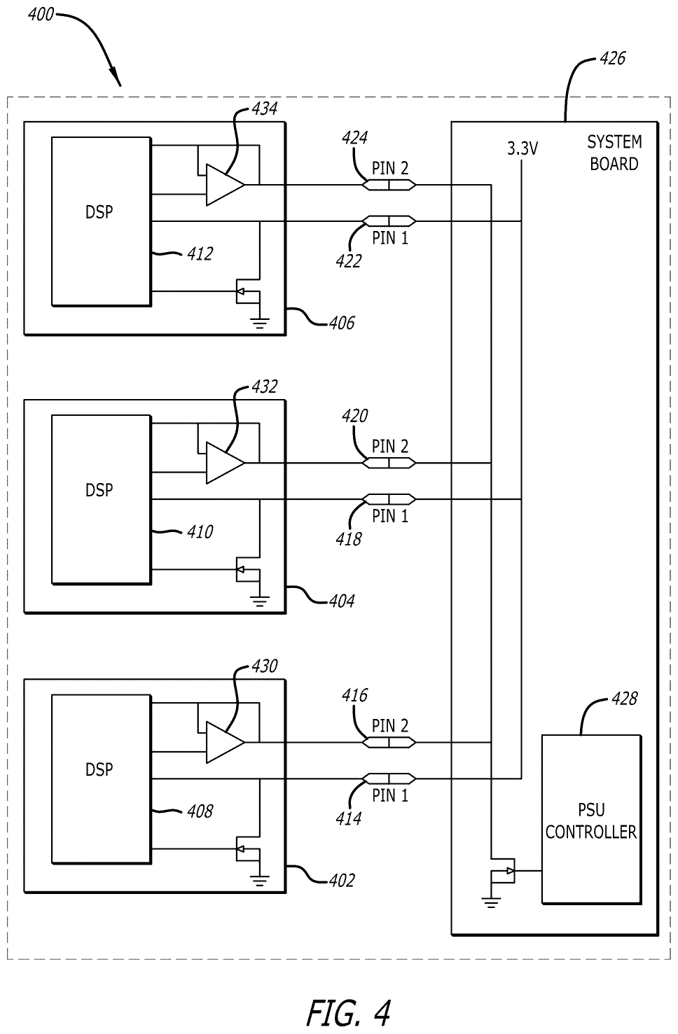

Referring to FIG. 4, a conceptual diagram 400 of a power supply system for a network device in accordance with various embodiments of the disclosure is shown. The embodiments depicted in the conceptual diagram 400 may show a scenario where a network device 400 includes a plurality of PSUs, for example, first through third PSUs 402, 404, 406. In many embodiments, each of the first through third PSUs 402, 404, 406 may be configured with a first pin (e.g., a first configuration pin) and a second pin (e.g., a second configuration pin). In numerous embodiments, the first through third PSUs 402, 404, 406 may be connected in a parallel configuration and supplying power to a load.

In numerous embodiments, the first pin may be an assignment pin utilized to indicate whether a PSU is a primary power supply or a secondary power supply. The primary power supply may refer to the main source of power supply for the network device 400. The secondary power supply may refer to a backup power supply utilized for providing additional power, fault managed power, redundancy, etc. in the network device 400. The second pin may be utilized to indicate an activity state, such as an active state or a sleep state. As depicted in the FIG. 4, the first PSU 402 may be configured with the first pin “PIN1 414” and the second pin “PIN2 416”. Similarly, the second PSU 404 may be configured with the first pin “PIN1 418” and the second pin “PIN2 420”. The third PSU 406 may be configured with the first pin “PIN1 422” and the second pin “PIN2 424”.

In a number of embodiments, FIG. 4 further depicts a system board 426 coupled to the first through third PSUs 402, 404, 406. The first pins and the second pins of the first through third PSUs 402, 404, 406 may serve as a connection interface to the system board 426. The system board 426 may include a PSU controller 428. The PSU controller 428 may include suitable circuitry, logic, or interface that are configured to perform various operations such as manage, regulate, and optimize the power delivered to various components and systems. The PSU controller 428 may also monitor the voltage levels, current levels, temperature, or other parameters of each of the first through third PSUs 402, 404, 406. Examples of the PSU controller 428 may include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Digital Signal Processor (DSP), or the like.

In further embodiments, the PSU controller 428 may be responsible for monitoring and controlling of the first through third PSUs 402, 404, 406. The PSU controller 428 may also provide redundancy management by monitoring the status of each PSU and dynamically managing the load by switching to a secondary PSU if the primary PSU fails. In still more embodiments, the PSU controller 428 may also store operational parameters of the first through third PSUs 402, 404, 406 in a memory element. The operational parameters may include efficiency curve, power factor, quality (such as voltage regulation and stability, reliability, etc.), or the like of the first through third PSUs 402, 404, 406. The PSU controller 428 may also store information regarding the physical location of the first through third PSUs 402, 404, 406 within the network device 400. In still further embodiments, the PSU controller 428 may be configured to determine which of the first through third PSUs 402, 404, 406 may operate as a primary PSU and which ones may operate as secondary PSUs. For example, the PSU controller 428 may determine the assignment (e.g., primary or secondary) for each of the first through third PSUs 402, 404, 406 based on the operational parameters, location of the PSU within the network device 400, or a combination thereof. The PSU controller 428 may further store a mapping associating different voltage levels to different assignments. For example, in the mapping, ‘3V’ may be associated with the primary PSU assignment and ‘2.48V’ may be associated with the secondary PSU assignment.

Upon determining the assignment of the first through third PSUs 402, 404, 406, the PSU controller 428 may be configured to provide a voltage level corresponding to the assignment at the first pins of the first through third PSUs 402, 404, 406. In numerous embodiments, the first pins of the first through third PSUs 402, 404, 406 may be connected to the same input voltage line of the PSU controller 428 and the first through third PSUs 402, 404, 406 may check their first pins at different periodic time intervals. Thus, the PSU controller 428 can supply the corresponding voltage level at the input voltage line, matching the assignment of the PSU which is currently checking its first pin. For example, if at a time instance ‘T1” the first PSU 402 is to check the PIN1 414, the PSU controller 428 may provide a voltage level that matches the determined assignment of the first PSU 402. Likewise, if at a time instance ‘T2”, the second PSU 404 is to check the PIN1 418, the PSU controller 428 may provide a voltage level that matches the determined assignment of the second PSU 404. For the ongoing description and in a non-limiting example, it is assumed that the PSU controller 428 assigns the first PSU 402 as “the primary PSU”, the second PSU 404 as the “first secondary PSU”, and the third PSU 406 as the “second secondary PSU” via the respective first pins PIN1 414, PIN1 418, PIN1 422. In a variety of embodiments, in case the primary PSU 402 experiences a failure condition, the PSU controller 428 may provide a voltage level of ‘3V’ at the assignment pin of the first secondary PSU 404 at the time instance T2. Thus, the first secondary PSU 404 may be assigned as a new primary PSU 404.

In still further embodiments, each of the first through third PSUs 402, 404, 406 may each include a DSP 408, 410, 412, respectively. The first through third DSPs 408, 410, 412 may include a logic circuit. In yet more embodiments, the PSU controller 428 may provide a voltage level on the second pin of the first through third PSUs 402, 404, 406. The voltage level may be associated with the activity state of the first through third PSUs 402, 404, 406. Each of the first through third PSUs 402, 404, 406 may store a list of activation thresholds corresponding to different activity state in the respective logic circuit. For example, the list of activation thresholds may indicate that a first voltage level≤3V at the PIN2 416 of the primary PSU 402 may indicate that the primary PSU 402 is in active state. Likewise, a second voltage level≤2.3V at the PIN2 420 of the first secondary PSU 404 may indicate that the first secondary PSU 404 is in the active state. Further, a third voltage level between ≤1.6V at the PIN2 424 of the second secondary PSU 406 may indicate that the second secondary PSU 406 is in the active state, and so on.

In several embodiments, each of the PSUs 402, 404, 406 may also include a comparator 430, 432, 434, respectively, configured to read the voltage level present at the second pin of the respective PSUs. Although each of the comparators 430, 432, 434 may be configured to read and compare the voltage level present at the second configuration pin with the activation thresholds for each of the PSUs 402, 404, 406, various circuits can substitute for a comparator depending on the application and requirements. One such alternative is the op-amp configured as a voltage follower with a high gain, which can perform similar comparison tasks by amplifying the difference between two input voltages. For digital signal processing, a microcontroller with built-in ADCs can be programmed to compare input signals and execute conditional logic, thus replacing a traditional comparator. Another substitute is a differential amplifier circuit, which amplifies the difference between two input signals and can be used in precision applications where a comparator's speed and simplicity are less critical. For specific applications like zero-crossing detection or signal threshold monitoring, a microcontroller with integrated comparators can provide a more compact and programmable solution. Additionally, logic gates configured to mimic comparator behavior can serve as an alternative in digital circuits, though this approach might be more complex.

In still yet more embodiments, when the primary PSU 402 reads a voltage level of 3V present at the PIN2 416, the logic circuit (for example, the DSP 408) may compare the voltage level at the second pin with the activation threshold. Since the voltage level of 3V is within the activation threshold, the primary PSU 420 may change its activity state from a sleep state to an active state. In many further embodiments, the primary PSU 402 may be configured to change the activity state of any of the secondary PSUs based on a load requirement. For example, if the load demand increases beyond the capacity of the primary PSU 402 operating in the active state, the primary PSU 402 may change a voltage level at its PIN2 416. Change in the voltage level at the PIN2 416 of the primary PSU 402 may also be reflected at the corresponding PIN2 of each of the first secondary PSU 404 and the second secondary PSU 406. For example, PIN2 of all PSUs can be connected or the PSU controller 428 may cause the voltage level change at the PIN2 of each of the first secondary PSU 404 and the second secondary PSU 406 in response to the change at the voltage level of the primary PSU 402. Based on the change in the voltage level at the PIN2 of the first secondary PSU 404 and the second secondary PSU 406, at least one of the secondary PSUs whose activation threshold matches the new voltage level at the PIN2 may change the activity state from the sleep state to the active state. In more examples, where the primary PSU 402 fails, the PSU controller 428 may change a voltage level at PIN1 of at least one of the first secondary PSU 404 and the second secondary PSU 406 to change the assignment from secondary to primary and may further change a voltage level at PIN2 to change the activity state from the sleep state to the active state. In many further embodiments, the change in the activity state can occur in less than 100 milliseconds. Further, the change in the activity state can occur without a signal from a centralized control software of the network device.

Although a specific embodiment of a power supply system for a network device suitable for carrying out the various steps, processes, methods, and operations described herein is discussed with respect to FIG. 4, any of a variety of systems and/or processes may be utilized in accordance with embodiments of the disclosure. In many further embodiments, the secondary PSUs may not be ranked in the order of priority. Thus, any secondary PSU from among the plurality of secondary PSUs can be used as a first secondary PSU without referring to any particular order of operation. The elements depicted in FIG. 4 may also be interchangeable with other elements of FIGS. 1-3 and 5-9 as required to realize a particularly desired embodiment.

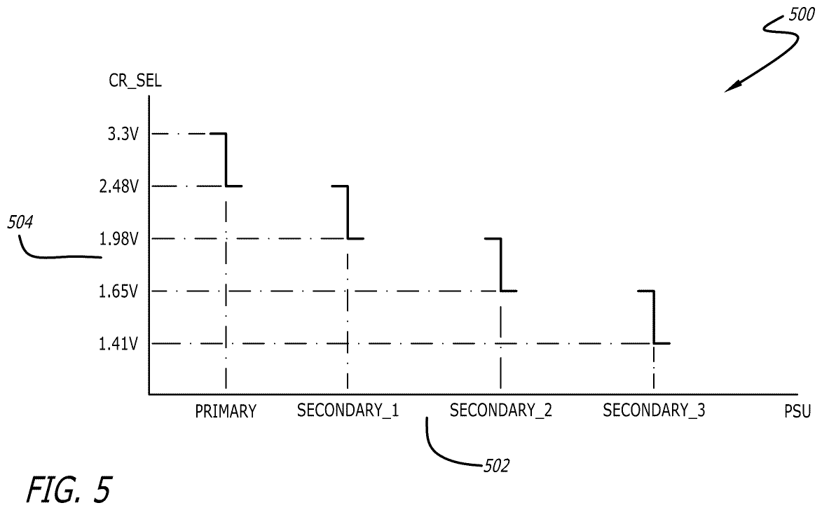

Referring to FIG. 5, a graphical illustration depicting voltage levels mapped to different assignments in accordance with various embodiments of the disclosure is shown. The embodiments shown in FIG. 5 depicts a graph 500. The graph 500 illustrates different voltage levels, for example, 3.3V, 2.48V, 1.98V, and 1.65V, mapped to different assignments, for example, Primary, Secondary_1, Secondary_2, Secondary_3, respectively. The different voltage levels (referred to as CR_SEL) are shown along Y-axis 504 and the different assignments are shown along X-axis 502.

For example, if a first pin (e.g., an assignment pin) of a PSU is at 3.3V at the time the PSU is checking the first pin, the PSU may determine its assignment as “Primary”. Likewise, if a first pin (e.g., an assignment pin) of a PSU is at 1.98V at the time the PSU is checking the first pin, the PSU may determine its assignment as “Secondary_2”. The voltage levels at the first pin of each PSUs may differ to indicate different assignments. In other words, the first pin may be utilized by each PSU to determine its assignment.

A person with ordinary skill in the art would appreciate that the voltage levels depicted in FIG. 5 are for example purposes and should not be construed to limit the scope of the disclosure.

Although a specific embodiment depicting voltage levels mapped to different assignments suitable for carrying out the various steps, processes, methods, and operations described herein is discussed with respect to FIG. 5, any of a variety of systems and/or processes may be utilized in accordance with embodiments of the disclosure. In many further embodiments, the first pins of multiple PSUs may not be connected same input line of a PSU controller. In such scenario, the assignments can be provided to the PSUs simultaneously, without waiting for their checking period. The elements depicted in FIG. 5 may also be interchangeable with other elements of FIGS. 1-4 and 6-9 as required to realize a particularly desired embodiment.

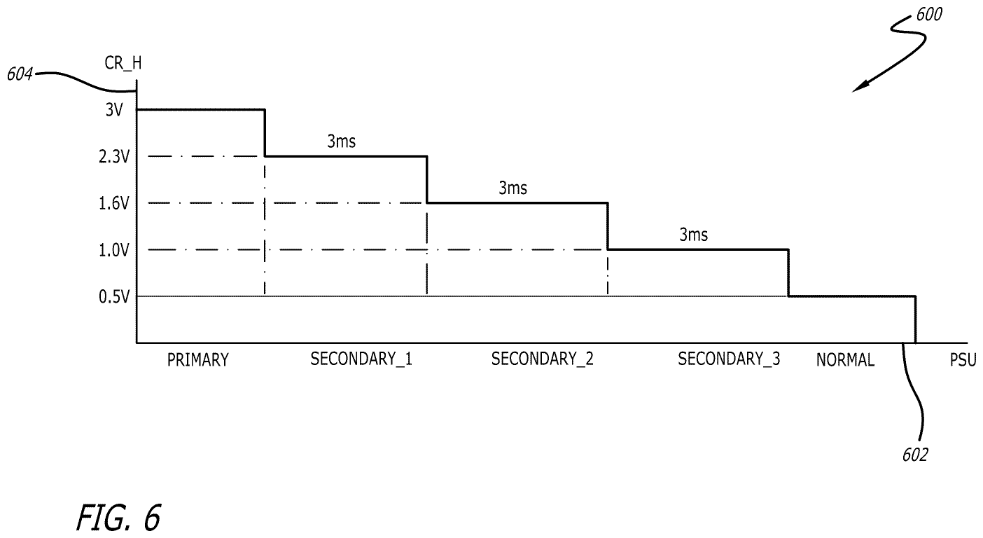

Referring to FIG. 6, a graphical illustration depicting a change in activity state of PSUs in accordance with various embodiments of the disclosure is shown. In many embodiments, a graph 600, depicted in FIG. 6, shows different voltage levels (indicated as CR_H) at which different PSUs change their activity state from a sleep state to an active state. The activity state may refer to the operational state of a PSU. For example, a PSU in the active state may supply required power for a load demand, whereas in the sleep state, the PSU stays in a standby mode. In standby mode, the PSU may operate in a low-power state with minimal energy consumption and without powering any load.

In a number of embodiments, the PSUs in a network device may read a voltage level present at an activity pin of the PSUs. The activity pin may determine the activity state for the PSUs. In an example scenario, if the activity pin reads a voltage level of 3V, the primary PSU may switch its activity state from the sleep state to the active state, while secondary PSUs (e.g., Secondary_1, Secondary_2, Secondary_3) remain in the sleep state. Here, the voltage level of 3V may act as an activation threshold voltage for the primary PSU. In a similar manner, the secondary_1 PSU may have an activation threshold voltage level of 2.3V. Thus, if the activity pin of the secondary_1 PSU receives the voltage level of 2.3V or less, the secondary_1 PSU may switch its activity state to the active state, for example, within 3 ms. Similarly, for other secondary PSUs, respective activation threshold voltage levels may be utilized to switch the activity state. In more embodiments, all the PSUs may operate in a normal mode if the voltage level at the activity pins of the PSUs is 0.5V. The normal mode may refer to a mode in which all PSUs operate in the active state. A person with ordinary skill in the art would appreciate that the voltage levels depicted in FIG. 6 are for example purposes and should not be construed to limit the scope of the disclosure.

Although a specific embodiment depicting a change in activity state of PSUs suitable for carrying out the various steps, processes, methods, and operations described herein is discussed with respect to FIG. 6, any of a variety of systems and/or processes may be utilized in accordance with embodiments of the disclosure. In further embodiments, a PSU may change its activity state from the sleep state to the active state in less than 100 milliseconds. The elements depicted in FIG. 6 may also be interchangeable with other elements of FIGS. 1-5 and 7-9 as required to realize a particularly desired embodiment.

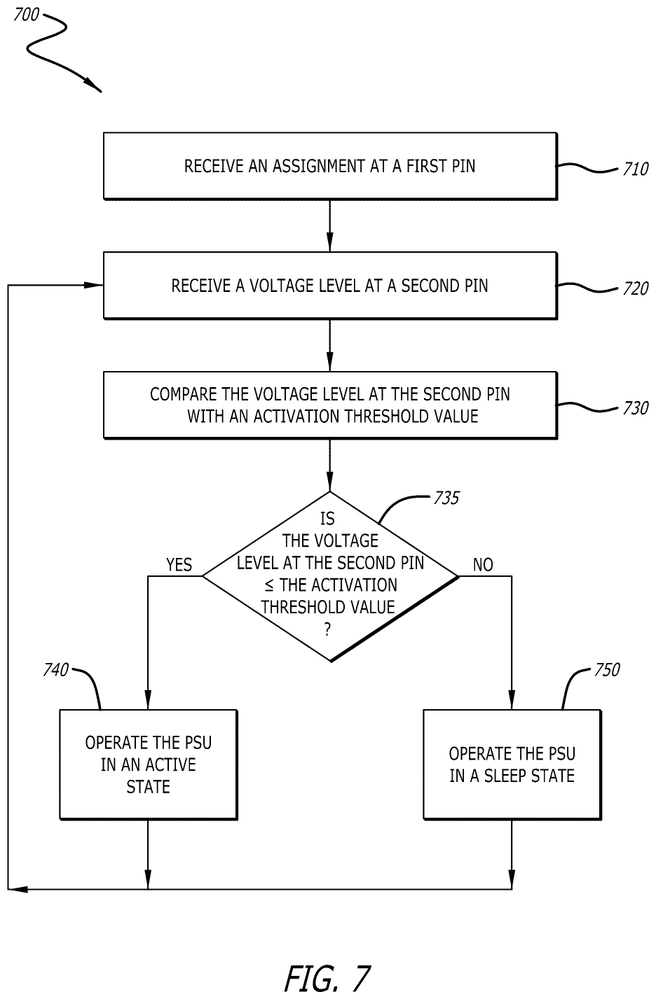

Referring to FIG. 7, a flowchart showing a process 700 of operating a power supply unit (PSU) with two analog pins in accordance with various embodiments of the disclosure is shown. In many embodiments, the process 700 may receive an assignment at a first pin (block 710). The assignment may be configured to indicate whether the PSU is to operate as a primary power supply or a secondary power supply. The assignment may be determined based on a voltage level detected at the first pin of the PSU. Each assignment may be associated with a different voltage level.

In a number of embodiments, the process 700 may receive a voltage level at a second pin (block 720). The process 700 may read the voltage level present at the second pin. The voltage level at the second pin may be configured to indicate or set an activity state of the PSU. The activity state of the PSU may refer to an active state or a sleep state.

In a variety of embodiments, the process 700 may compare the voltage level at the second pin with an activation threshold value (block 730). The activation threshold value may refer to a voltage value stored in a memory element of the PSU. The activation threshold value may indicate a voltage level at which the PSU may switch its activity state from the sleep state to the active state. In numerous embodiments, the activation threshold value may be a predetermined operational configuration setup through one or more logic circuits in the PSU. Further, the activation threshold value can be different for different assignments. Thus, ensuring that not all secondary PSUs change their activity state at the same time unless required.

In additional embodiments, the process 700 may check whether the voltage level at the second pin is less than the activation threshold value (block 735). If the process 700 determines that the voltage level at the second pin is less than the activation threshold value, the process 700 may operate the PSU in an active state (block 740). In other words, the process 700 may switch the PSU from the sleep state to the active state based on the voltage level read at the second pin. In further embodiments, the process 700 may check the voltage level at the second pin at next periodic interval (block 720).

However, if the voltage level at the second pin is not less than the activation threshold value, the process 700 may operate the PSU in the sleep state (block 750). The sleep state may also be referred to as low power state or standby state in which the PSU does not power any load. The PSU may operate with minimal energy consumption. The process 700 may then check the voltage level at the second pin at next periodic interval (block 720).

Although a specific embodiment of operating a power supply unit (PSU) with two analog pins suitable for carrying out the various steps, processes, methods, and operations described herein is discussed with respect to FIG. 7, any of a variety of systems and/or processes may be utilized in accordance with embodiments of the disclosure. In still more embodiments, the second pins of the PSUs may be interconnected. Thus, when the primary PSU experiences a surge in load demand, the primary PSU may change the voltage level at its second pin to change the activity state of at least one secondary PSU to the active state. Thus, the process 700 may change the activity state of the PSU without receiving a signal from a centralized control software. The process 700 may use analog voltage values to determine the change in the activity state. The elements depicted in FIG. 7 may also be interchangeable with other elements of FIGS. 1-6 and 8-9 as required to realize a particularly desired embodiment.

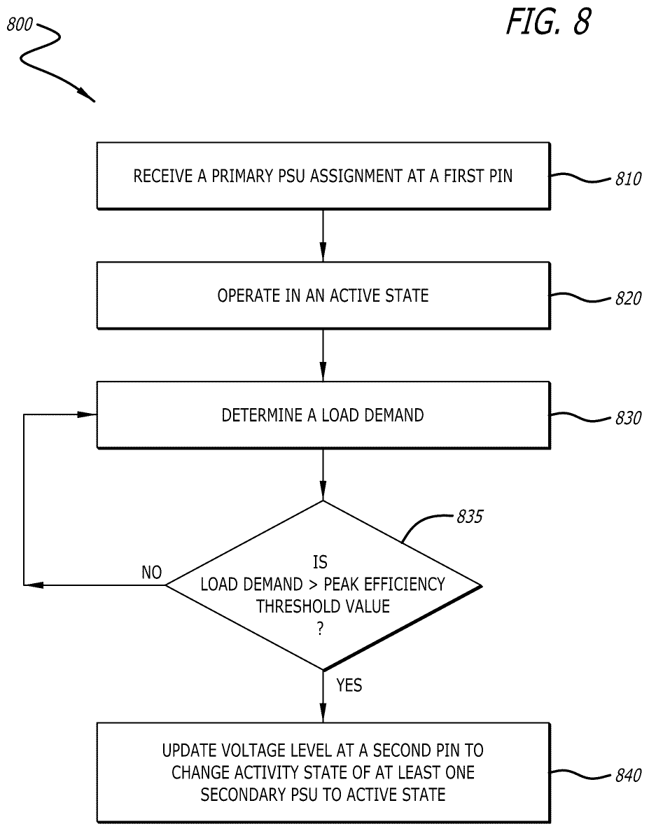

Referring to FIG. 8, a flowchart showing a process 800 for operating a primary PSU in a cold redundancy set up in accordance with various embodiments of the disclosure is shown. In many embodiments, the process 800 may receive a primary PSU assignment at a first pin (block 810). The assignment may be configured to indicate whether the PSU is to operate as a primary power supply or a secondary power supply. The assignment may be determined based on a voltage level detected at the first pin of the PSU. Each assignment may be associated with a different voltage level.

The assignment may be configured to indicate that one of the two or more power supplies is a primary power supply. In a number of embodiments, the assignment may be further configured to indicate that the remaining power supplies of the two or more power supplies is a secondary power supply. In a variety of embodiments, the process 800 may provide the assignment by means of different voltage levels used for selecting lines for different PSUs. For example, for a primary PSU, the process 800 may enable a select line with 3.3V level, thus enabling the primary PSU.

In a variety of embodiments, the process 800 may operate in an active state (block 820). The process 800 may receive a voltage level at the second pin. The voltage level may be configured to indicate or set an activity state of the PSU. The PSU may compare the received voltage level at the second pin with an activation threshold value. If the voltage level at the second pin is less than the activation threshold value, the PSU may switch its activity state to the active state.

In additional embodiments, the process 800 may determine a load demand (block 830). The load demand may refer to power required by internal components such as processors, memory, networking interfaces, other internal components, or peripheral devices of a network device (for example, a router). The process 800 may, thus, determine how many PSUs may be required to satisfy the load demand.

In additional embodiments, the process 800 checks whether the load demand is greater than the peak efficiency threshold value (block 835). The process 800 may continuously check whether the PSU currently supplying the load demand is operating efficiently. A PSU usually operates at peak efficiency for approximately 50-60% of the load demand value. When the load demand starts to increase the efficiency of the PSU may dip from the peak efficiency value.

If the load demand is determined to be greater than the peak efficiency threshold value, the process 800 may update voltage level at a second pin to change activity state of at least one secondary PSU to active state (block 840). When the process 800 may determine a surge in the load demand, the voltage level at the second pin may be changed to change the voltage level at a second pin of at least one secondary PSU, thereby changing the activity state of the at least one secondary PSU to the active state. However, if the load demand is less than the peak efficiency threshold value, the process 800 may continue to check the load demand (block 830). In several embodiments, the process 800 may determine the load demand in a periodic interval.

Although a specific embodiment for operating a primary PSU in a cold redundancy set up suitable for carrying out the various steps, processes, methods, and operations described herein is discussed with respect to FIG. 8, any of a variety of systems and/or processes may be utilized in accordance with embodiments of the disclosure. In yet more embodiments, the process 800 may change the activity state of the selected one or more PSUs in less than 100 milliseconds. The elements depicted in FIG. 8 may also be interchangeable with other elements of FIGS. 1-7 and 9 as required to realize a particularly desired embodiment.

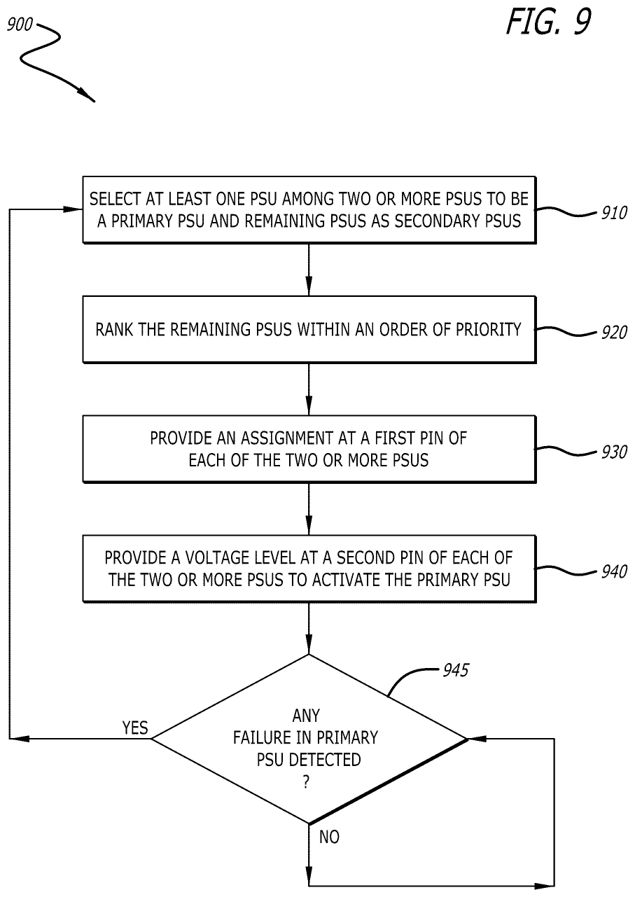

Referring to FIG. 9, a flowchart showing a process 900 for a power supply system with two or more PSUs and a system board in accordance with various embodiments of the disclosure is shown. In many embodiments, the process 900 may select at least one PSU among two or more PSUs to be a primary PSU and remaining PSUs as secondary PSUs (block 910). The process 900 may select at least one PSU to be a primary PSU based on a determined load requirement.

In a number of embodiments, the process 900 may rank the remaining PSUs within an order of priority (block 920). The process 900 may rank all the remaining PSUs, referred to as secondary PSUs, as a first secondary, a second secondary, a third secondary, and so on. In a variety of embodiments, the process 900 may rank the secondary PSUs based on predetermined operational configurations stored in a memory element. The predetermined operational configurations may refer to quality of the PSU, efficiency curve, power factor, phase to which a PSU is connected to, location of the PSU on the system board, or the like. Based on a combination of these factors, the process 900 may rank the secondary PSUs within an order of priority. For example, if the primary PSU fails, a standby PSU (from among the secondary PSUs) may be selected in a manner that can provide optimal efficiency. Thus, the process 900 may rank the secondary PSUs enabling the selection of the next best PSU to supply power efficiently and prevents random selection of any secondary PSU from among the remaining PSUs which may result in inefficient performance.

In more embodiments, the process 900 may provide an assignment at a first pin of each of the two or more PSUs (block 930). The assignment may be configured to indicate that one of the two or more power supplies is a primary power supply. In a number of embodiments, the assignment may be further configured to indicate that the remaining power supplies of the two or more power supplies is a secondary power supply.

In additional embodiments, the process 900 may provide a voltage level at a second pin of each of the two or more PSUs to activate the primary PSU (block 940). The voltage level may be configured to indicate or set an activity state of the primary PSU. The primary PSU may compare the received voltage level at the second pin with an activation threshold value. If the voltage level at the second pin is less than the activation threshold value, the PSU may switch its activity state to the active state. For example, the second pin may receive a voltage of 3V, which may be less than the activation threshold value for the primary PSU. Thus, the primary PSU may change its activity state from a sleep state to an active state.

In still further embodiments, the process 900 may detect if there is any failure in the primary PSU (block 945). The primary PSU may suffer failure due to voltage fluctuations, overheat conditions, fan failure, MOSFET or Integrated Chip (IP) failure, or various other reasons. Thus, under the failure conditions, the primary PSU can no longer supply power to the internal components of a network device. If the failure of the primary PSU is detected, the process 900 may select at least one PSU among two or more PSUs to be a primary PSU and remaining PSUs as secondary PSUs (block 910). The process 900 may again run the process of selecting a new primary PSU from among the remaining PSUs after the failure of the primary PSU. However, if no failure of the primary PSU is detected, the process 900 may continue the checking process for detection of a failure of the primary PSU (block 945). In several embodiments, the process 900 may check for any failure in the primary PSU in periodic intervals.

Although a specific embodiment for a power supply system with two or more PSUs and a system board suitable for carrying out the various steps, processes, methods, and operations described herein is discussed with respect to FIG. 9, any of a variety of systems and/or processes may be utilized in accordance with embodiments of the disclosure. In several embodiments, the process 900 may change the activity state of the primary PSU in response to both a current assignment and the voltage level at the second pin. For example, the process 900 may change the activity state of the primary PSU as active based on the assignment of the PSU as primary and the voltage level at the second pin being less than the threshold voltage level. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

1. A power supply system, comprising:
a system board;
two or more power supplies electrically coupled to the system board, wherein:
each of the two or more power supplies is configured with a first pin and a second pin;
the first pin is utilized by each of the two or more power supplies to determine an assignment; and
the second pin is utilized by each of the two or more power supplies to determine an activity state; and
a power supply unit (PSU) controller configured to provide a first voltage level at the first pin to convey a corresponding assignment, and provide a second voltage level at the second pin to convey a corresponding initial activity state;
wherein the first voltage level is different from the second voltage level, and wherein each of the power supplies operates in an active state if the second voltage level is less than an activation threshold value.

2. The power supply system of claim 1, wherein the assignment is configured to indicate that one of the two or more power supplies is a primary power supply.

3. The power supply system of claim 2, wherein the assignment is configured to indicate that remaining power supplies of the two or more power supplies is a secondary power supply.

4. The power supply system of claim 3, wherein each of the secondary power supplies are ranked within an order of priority.

5. The power supply system of claim 4, wherein the ranks comprise at least a first secondary, a second secondary, and a third secondary.

6. The power supply system of claim 4, wherein the activity state includes an active state.

7. The power supply system of claim 6, wherein the activity state includes a sleep state.

8. The power supply system of claim 7, wherein the primary power supply is configured with an active state.

9. The power supply system of claim 8, wherein the second pin is configured to be associated with a voltage level that:
is present at the second pin; and
is readable by the power supply.

10. The power supply system of claim 9, wherein the activity state is changed in response to a change in the voltage level present at the second pin.

11. The power supply system of claim 10, wherein each of the two or more power supplies is configured to change corresponding activity state in response to both a current assignment and the voltage level at the second pin.

12. The power supply system of claim 11, wherein the change in activity state is based on a predetermined operational configuration.

13. The power supply system of claim 12, wherein the predetermined operational configuration is setup through one or more logic circuits.

14. The power supply system of claim 13, wherein the change in activity state occurs in less than 100 milliseconds.

15. The power supply system of claim 13, wherein the change in activity state occurs without a signal from a centralized control software.

16. A power supply, comprising:
at least one logic circuit;
a first configuration pin, configured to determine an assignment;
a second configuration pin that is utilized by the at least one logic circuit to determine an activity state of the power supply;
a power supply unit (PSU) controller configured to provide a first voltage level at the first configuration pin to convey a corresponding assignment, and wherein a second voltage level at the second configuration pin conveys a corresponding initial activity state;
wherein the first voltage level is different from the second voltage level, and wherein the power supply operates in an active state if the second voltage level is less than an activation threshold value.

17. The power supply of claim 16, wherein the assignment is configured to indicate that the power supply is either a primary power supply or a secondary power supply.

18. The power supply of claim 17, wherein activity state is either an active state or a sleep state.

19. The power supply of claim 16, wherein the voltage level is checked in a periodic interval.

20. A method of managing power supplies, comprising:
determining, by a power supply unit (PSU) controller, an assignment among a plurality of power supplies coupled to a system board based on a first voltage level applied to a first configuration pin of each of the plurality of power supplies; and
providing a second voltage level to a second configuration pin of each of the plurality of power supplies to convey a corresponding activity state;
wherein the first voltage level is different from the second voltage level, and wherein a power supply operates in an active state if the second voltage level is less than an activation threshold value, the activation threshold value comprising a voltage value stored in a memory element of the PSU.
